(19) United States
(12) Patent Application Publication
(10) Pub. No.: US 2011/0107322 A1
(43) Pub. Date: May 5, 2011

(54) NETWORK DEVICE, NETWORK DEVICE SYSTEM AND SOFTWARE UPDATE METHOD OF NETWORK DEVICE

(75) Inventor: Hiroyuki Hashiguchi, Kagoshima-shi (JP)

(73) Assignee: SEIKO EPSON CORPORATION, Shinjuku-ku (JP)

(21) Appl. No.: 12/914,806

(22) Filed: Oct. 28, 2010

(30) Foreign Application Priority Data
Oct. 29, 2009 (JP) 2009-248537

(51) Int. Cl. G06F 9/44

(52) U.S. Cl. 717/170

(57) ABSTRACT

Provided is a network device which is connected to a network and in which prescribed software is installed. The network device includes: a communication section that communicates with a different network device through the network; a management section that manages a version of the prescribed software which is installed; a determination section that determines whether or not to change the prescribed software, which should be installed, on the basis of a result of comparison between the version of the prescribed software which is managed by the management section and a version of the prescribed software which is installed in the different network device.

### BACKGROUND

1. Technical Field

The present invention relates to a network device, a network device system, and a software update method of network device.

2. Related Art

Generally, when software, which is installed in electronic devices so as to control the electronic devices, is intended to be changed, it is necessary to change the ROM or CPU itself which is mounted in the electronic devices, and it is also necessary to carry out a very cumbersome technique for the change. However, recently due to widespread use of electrically rewritable nonvolatile memories, in the various electronic devices including printing apparatuses such as a printer, digital cameras, videos, copying apparatuses, and the like, products capable of rewriting control software (firmware) of corresponding devices by downloading software from a server on the network, an IC card, or the like have increased.

As described above, in the electronic devices capable of downloading software, not only correcting of a software problem but also adding of new functions can be carried out by a comparatively simple operation. However, even in the case of the simple operation, in the production departments of factories, there are circumferences in which several tens to several hundreds of apparatuses exist on one floor in one lot. For this reason, even the rewriting work which is relatively simple, a great effort is necessary to update software for each single apparatus.

In order to reduce the effort, in the related art, there has been proposed a configuration in which software rewriting is performed in a way that a manager of a server performs an operation so as to load new software onto the server on the network and electronic devices connected to the network download the new software from the server (for example, JP-A-9-251355). With such a configuration, even when several electronic devices are used in connection with each other on the network, if the latest software is retained in one server, it is possible to automatically update the software of the electronic devices into the latest version.

As it is, since it is necessary for the manager of the server to load the latest software onto the server by acquiring update information of the software by a certain method, this is a burden for the manager. In addition, when the manager of the server does not notice the update of the software, the software is not updated, and thus there is a problem in that it takes time to manage the software version. Further, a user of one electronic device is aware of the update information of the software, and updates the software only for the electronic device that he or she uses. For this reason, a problem arises in that the versions of the software of the electronic devices connected to the network are not the same.

### SUMMARY

An advantage of some aspects of the invention is to facilitate update of software installed in a plurality of electronic devices connected to the network and simultaneously facilitate the management of the version of the installed software.

The invention has been made to solve at least some of the problems mentioned above, and can be embodied in the following forms or application examples.

### Application Example 1

In an application example according to an aspect of the invention, there is provided a network device which is connected to a network and in which prescribed software is installed. The network device includes: a communication section that communicates with a different network device through the network; a management section that manages a version of the prescribed software which is installed; a determination section that determines whether or not to change the prescribed software, which should be installed, on the basis of a result of comparison between the version of the prescribed software which is managed by the management section and a version of the prescribed software which is installed in the different network device; and a control section that, when the prescribed software which is installed is updated, transmits a version of the prescribed software, which is updated, from the communication section to the different network device, and additionally provides the prescribed software, which is updated, to the different network devices in response to a request from a different network device, and on the other hand, when the communication section receives the version of the prescribed software which is installed in the different network device and the determination section determines to change the prescribed software which should be installed, acquires the prescribed software from the different network device, and installs the prescribed software which is acquired instead of the prescribed software which is currently installed.

With such a configuration, when the prescribed software which is installed is updated, the version of the prescribed software which is updated is acquired, the acquired version is transmitted to the different network device, and the prescribed software which is updated is additionally provided to the different network device in response to the request from the different network device. On the other hand, when the version of the prescribed software which is installed in the different network device is received, it is determined whether or not to change the prescribed software which should be installed. Then, when it is determined to change the prescribed software, the prescribed software is acquired from the different network device, and the prescribed software which is acquired is installed instead of the prescribed software which is currently installed. Accordingly, when the prescribed software which is installed in the different network device is updated, the updated version is transmitted from the different network device, and the change is determined on the basis of the comparison between the received version and the version of the software which is installed in the subject device, thereby updating the installed software. As a result, since the version of the software is unified among the network devices, it is possible to easily manage the version of the software without using the server or the server manager.

### Application Example 2

In the network device according to the above-mentioned application example, it is preferable that the determination section should determine to change the prescribed software which should be installed when the version of the prescribed software which is installed in the different network device is more recent than the version of the prescribed software which is installed.

With such a configuration, it is possible to change the software which is installed in the network device with the latest version which is installed in the different network device.

### Application Example 3

In the network device according to the above-mentioned application example, it is preferable that the determination section should determine not to change the prescribed software which should be installed when the version of the prescribed software which is installed is more recent than the version of the prescribed software which is installed in the different network device.

### Application Example 4

In the network device according to the above-mentioned application example, it is preferable that the determination section should determine to change the prescribed software which should be installed when the version of the prescribed software which is installed in the different network device is a prescribed version.

With such a configuration, it is possible to set the version of the software which is installed in the network device as the prescribed version.

### Application Example 5

In the network device according to the above-mentioned application example, it is preferable that the prescribed software should be a firmware which controls the network device in which the prescribed software is installed.

### Application Example 6

In an application example according to another aspect of the invention, there is provided a network device system in which a plurality of network devices each containing the prescribed software installed therein are connected to each other so as to able to communicate with each other through a network. When the prescribed software which is installed is updated, a first network device of the network devices acquires a version of the prescribed software which is updated, transmits the acquired version from the network to a second network device of the network devices, and additionally provides the prescribed software, which is updated, to the second network device in response to a request from the second network device. When the version of the prescribed software is received from the first network device and it is determined to change the prescribed software by determining whether or not to change the prescribed software, which should be installed, on the basis of the version, the second network device acquires the prescribed software by requesting the first network device to transmit the prescribed software, and installs the prescribed software which is acquired instead of the prescribed software which is currently installed.

With such a configuration, when the prescribed software which is installed is updated, the version of the prescribed software which is updated is acquired, the acquired version is transmitted to the different network device, and the prescribed software which is updated is additionally provided to the different network device in response to the request from the different network device. On the other hand, when the version of the prescribed software which is installed in the different network device is received, it is determined whether or not to change the prescribed software which should be installed. Then, when it is determined to change the prescribed software, the prescribed software is acquired from the different network device, and the prescribed software which is acquired is installed instead of the prescribed software which is currently installed. Accordingly, when the prescribed software which is installed in the different network device is updated, the updated version is transmitted from the different network, and the change is determined on the basis of the comparison between the received version and the version of the software which is installed in the subject device, thereby updating the installed software. As a result, since the version of the software is unified among the network devices, it is possible to easily manage the version of the software without using the server or the server manager.

### Application Example 7

In an application example according to a further aspect of the invention, there is provided a software update method of a network device which is connected to a network and in which prescribed software is installed. The method includes: a transmission process of acquiring a version of the prescribed software which is updated when the prescribed software which is installed is updated and transmitting the acquired version from the network to a different network device; a provision process of providing the prescribed software, which is updated, to the different network device in response to a request from the different network device; a reception process of receiving the version of the prescribed software from the different network device; a determination process of determining whether or not to change the prescribed software, which should be installed, on the basis of the received version; an acquisition process of acquiring the prescribed software from the different network device when it is determined to change the prescribed software; and an install process of installing the prescribed software, which is acquired, instead of the prescribed software which is currently installed.

With such a configuration, when the prescribed software which is installed is updated, the version of the prescribed software which is updated is acquired, the acquired version is transmitted to the different network device, and the prescribed software which is updated is additionally provided to the different network device in response to the request from the different network device. On the other hand, when the version of the prescribed software which is installed in the different network device is received, it is determined whether or not to change the prescribed software which should be installed. Then, when it is determined to change the prescribed software, the prescribed software is acquired from the different network device, and the prescribed software which is acquired is installed instead of the prescribed software which is currently installed. Accordingly, when the prescribed software which is installed in the different network device is updated, the updated version is transmitted from the different network, and the change is determined on the basis of the comparison between the received version and the version of the software which is installed in the subject device, thereby updating the installed software. As a result, since the version of the software is unified among the network devices, it is possible to easily manage the version of the software without using the server or the server manager.

### BRIEF DESCRIPTION OF THE DRAWINGS

The invention will be described with reference to the accompanying drawings, wherein like numbers reference like elements.

FIG. 1 is a block diagram illustrating a configuration of a network device according to an embodiment of the invention.

FIG. 2 is a diagram illustrating an arrangement of the network devices according to the embodiment of the invention.

FIG. 3 is a flowchart illustrating the flow of a firmware update process in the network device.

### DESCRIPTION OF EXEMPLARY EMBODIMENTS

Hereinafter, the network device will be described with reference to the accompanying drawings.

### Embodiments

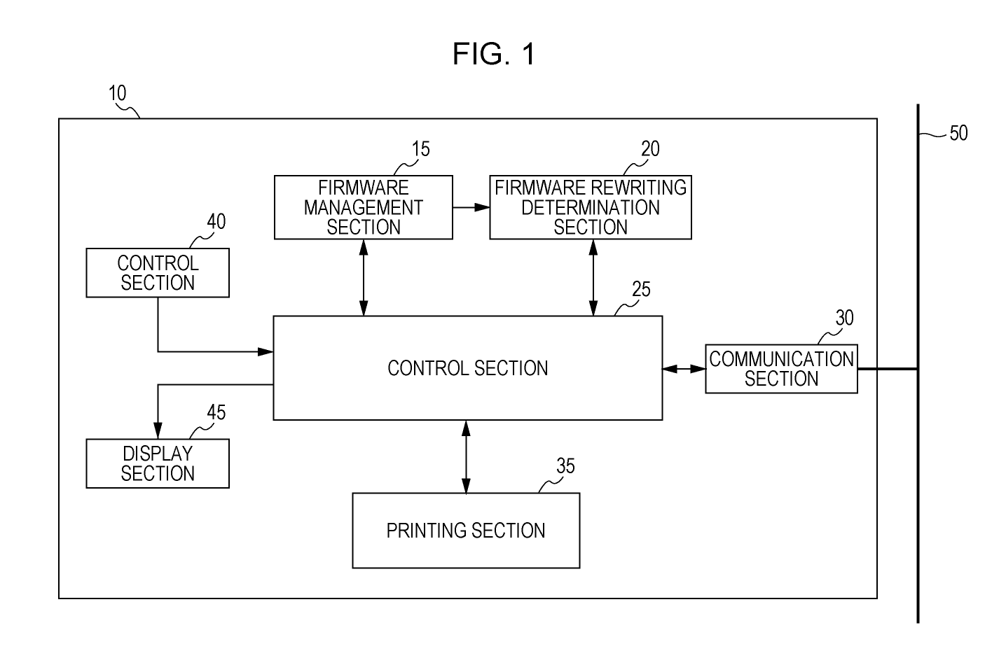

FIG. 1 is a block diagram illustrating a configuration of a network device 10. The network device 10 is considered as an information apparatus of which a function is controlled by firmware and which is able to update the firmware and transmit/receive data through a network 50. In the embodiment, the network devices 10 are considered as identical printer apparatuses, but are not limited to the identical apparatuses. For example, the network devices 10 may be different apparatuses such as a scanner apparatus, a copying apparatus, a facsimile apparatus, and a multifunction peripheral (MFP), which has a composite function of these, if only the apparatuses are able to control the function by using the same firmware.

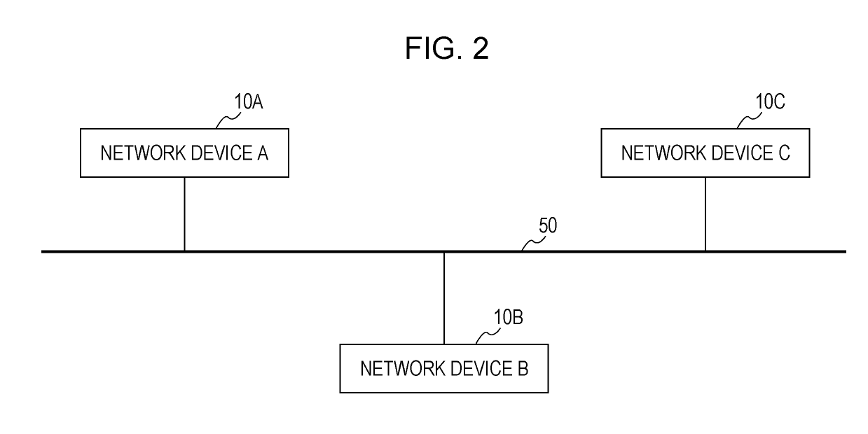

Further, in the embodiment, as shown in FIG. 2, network devices A (10A), B (10B), and C (10C), which can be driven with the same firmware, are connected to each other through the network 50. The network devices A (10A), B (10B), and C (10C) have substantially the same functional components, and the functional components of the network device 10 are described hereinafter.

The network device 10 includes a firmware management section 15, a firmware rewriting determination section 20, a control section 25, a communication section 30, a printing section 35, an operation section 40, and a display section 45.

The firmware management section 15 manages the firmware that is retained by the network device 10. Generally, the firmware resides in one or a plurality of nonvolatile memories such as a read only memory (ROM), a programmable ROM (PROM), an erasable programmable ROM (EPROM), and an electrically erasable programmable ROM (EEPROM). In the embodiment, the firmware management section 15 manages the version information of the firmware which resides in the memory. When the version of the firmware is upgraded by a user, the firmware management section 15 sends the upgraded version information to the firmware rewriting determination section 20.

The firmware rewriting determination section 20 compares, in response to the instruction of the control section 25, the version information of the different network device 10, which is received by the communication section 30, with the version information of the firmware, which is managed by the firmware management section 15, and determines whether to rewrite the firmware on the basis of the comparison result. In the embodiment, as a result of the comparison, when the version information of the different network device 10 is more recent than the version of the firmware which is managed by the firmware management section 15, it is determined to rewrite the firmware. In contrast, when the version of the firmware which is managed by the firmware management section 15 is more recent than the version information of the different network device 10, it is determined not to rewrite the firmware. Further, the determination of rewriting is not limited to the case mentioned above, and a case (downgrade) where the firmware is recovered to a prescribed old version (for example, an original version) may be considered. The information representing the result determined herein is sent to the control section 25.

The communication section 30 communicates with the different network device 10 through the network 50 in accordance with the instruction of the control section 25. Further, the printing section 35 prints print job data, which is generated by the network device 10, or print job data, which is sent through the network 50, in accordance with the instruction of the control section 25.

The operation section 40 sends the instruction to the control section 25 by a user's operation. Further, the display section 45 displays, in accordance with the instruction of the control section 25, a user interface screen such as an operation menu or information on the user.

The control section 25 has, although not shown, a RAM (Random Access Memory), a ROM, and a CPU (Central Processing Unit) as hardware, such hardware and various software organically cooperates, and the control section 25 thereby controls the functional sections.

When receiving the information representing the determination of rewriting from the firmware rewriting determination section 20, the control section 25 instructs the communication section 30 to perform TCP or FTP connection with the different network device 10, downloads the firmware from the different network device 10, and rewrites the firmware.

Further, when there is a request of connection from the different network device 10, the control section 25 instructs the communication section 30 to permit the connection, and enables the download of the installed firmware from the external.

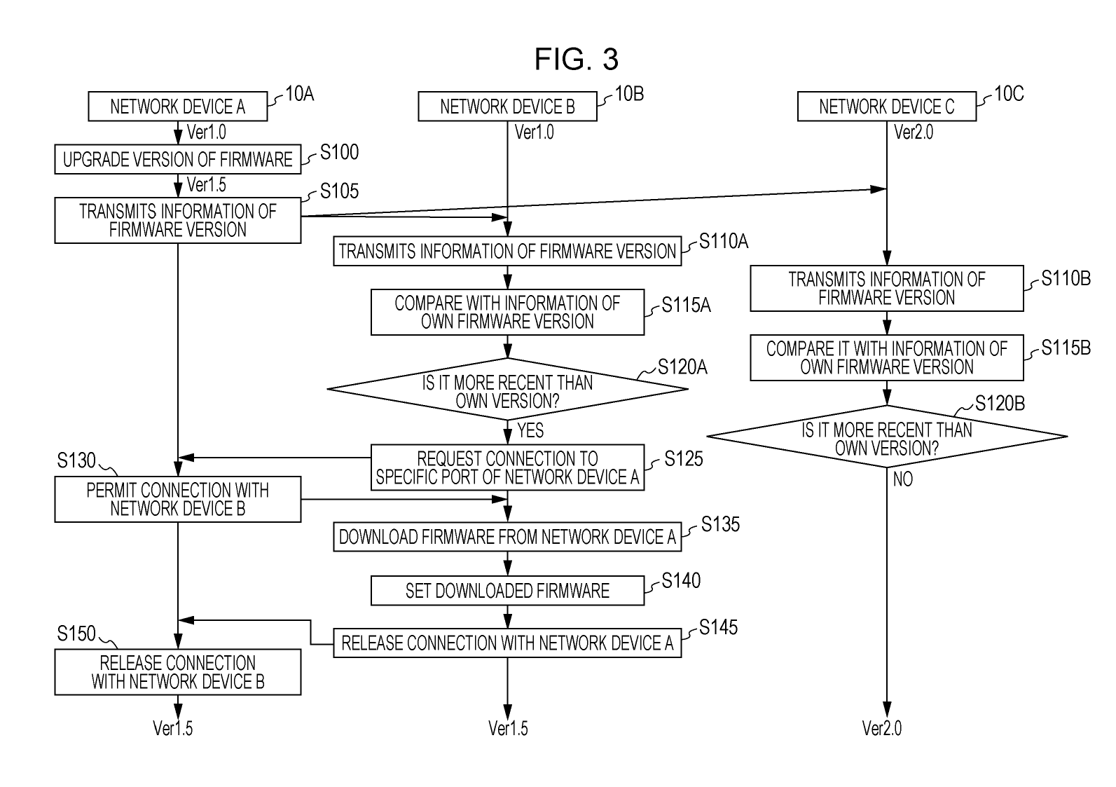

Next, FIG. 3 is a flowchart illustrating flow of the firmware update process performed in the network devices A (10A), B (10B), C (10C). Further, it is assumed that version 1.0 firmware is set in the network devices A (10A) and B (10B) in advance, and version 2.0 firmware is set in the network device C (10C) in advance.

First, a user upgrades the firmware of the network device A (10A) into version 1.5 (step S100). In response to this, the network device A (10A) transmits the set firmware version to different network devices B (10B) and C (10C) in a multicast mode (step S105; transmission process).

Next, the network devices B (10B) and C (10C) receive the version information of the firmware from the network device A (10A) (steps S110A and S110B; reception process). Subsequently, the network devices B (10B) and C (10C) compare the firmware version set in the subject device with the received firmware version (version 1.5) (steps S115A and S115B). Then, the network devices B (10B) and C (10C) determines whether or not the received firmware version is more recent than the firmware version set in the subject device (steps S120A and S120B; determination process).

Here, in the network device C (10C), the set firmware version is 2.0. Accordingly, the network device C (10C) determines that the received firmware version (1.5) is not more recent than the subject firmware version (No in step S120B), and thus terminates a sequence of the process without upgrading the version of the firmware.

On the other hand, in the network device B (10B), the set firmware version is 1.0. Accordingly, the network device B (10B) determines that the received firmware version is more recent than the subject firmware version (Yes in step S120A), and thus requests connection to a specific port of the network device A (10A) (step S125).

Next, the network device A (10A) enables the download of the subject firmware, and permits connection to the network device B (10B) (step S130; provision process). In response to this, the network device B (10B) downloads the firmware from the network device A (10A) (step S135; acquisition process), and installs and sets the downloaded firmware (step S140; install process).

Subsequently, the network device B (10B) requests the network device A (10A) to release the connection with the network device A (10A) (step S145). In response to this, the network device A (10A) releases the connection with the network device B (10B)(step S150), and terminates the sequence of the process.

By using the above-mentioned process, it is possible to drive the network devices with the same firmware, and it becomes easy to manage the set firmware version in the network devices A (10A), B (10B), and C (10C) which are connected to the network 50. As a result, it is possible to reduce the burden on the manager.

The embodiment of the invention has been described with reference to the drawings. However, the detailed configuration is not limited to the embodiment, and the invention includes design modification without departing from the technical scope of the invention. For example, available software is not limited to the firmware, and may be identical application software each of which is installed, ROM images which are files or other executable codes and data, BIOS (Basic Input Output System), and the like.

What is claimed is:

1. A network device which is connected to a network and in which prescribed software is installed, the network device comprising:
a communication section that communicates with a different network device through the network;
a management section that manages a version of the prescribed software which is installed;
a determination section that determines whether or not to change the prescribed software, which should be installed, on the basis of a result of comparison between the version of the prescribed software which is managed by the management section and a version of the prescribed software which is installed in the different network device; and
a control section that, when the prescribed software which is installed is updated, transmits a version of the prescribed software, which is updated, from the communication section to the different network device, and additionally provides the prescribed software, which is updated, to the different network device in response to a request from the different network device, and on the other hand, when the communication section receives the version of the prescribed software which is installed in the different network device and the determination section determines to change the prescribed software which should be installed, acquires the prescribed software from the different network device, and installs the prescribed software which is acquired instead of the prescribed software which is currently installed.

2. The network device according to claim 1,
wherein the determination section determines to change the prescribed software which should be installed when the version of the prescribed software which is installed in the different network device is more recent than the version of the prescribed software which is installed.

3. The network device according to claim 1,
wherein the determination section determines not to change the prescribed software which should be installed when the version of the prescribed software which is installed is more recent than the version of the prescribed software which is installed in the different network device.

4. The network device according to claim 1,
wherein the determination section determines to change the prescribed software which should be installed when the version of the prescribed software which is installed in the different network device is a prescribed version.

5. The network device according to claim 1,
wherein the prescribed software is a firmware which controls the network device in which the prescribed software is installed.

6. A network device system in which a plurality of network devices each containing the prescribed software installed therein are connected to each other so as to be able to communicate with each other through a network,
wherein when the prescribed software which is installed is updated, a first network device of the network devices acquires a version of the prescribed software which is updated, transmits the acquired version from the network to a second network device of the network devices, and additionally provides the prescribed software, which is updated, to the second network device in response to a request from the second network device, and
wherein when the version of the prescribed software is received from the first network device and it is determined to change the prescribed software by determining whether or not to change the prescribed software, which should be installed, on the basis of the version, the second network device acquires the prescribed software by requesting the first network device to transmit the prescribed software, and installs the prescribed software which is acquired instead of the prescribed software which is currently installed.

7. A software update method of a network device which is connected to a network and in which prescribed software is installed, the method comprising:
acquiring a version of the prescribed software which is updated when the prescribed software which is installed is updated and transmitting the acquired version from the network to a different network device;
providing the prescribed software, which is updated, to the different network device in response to a request from the different network device;
receiving the version of the prescribed software from the different network device;
determining whether or not to change the prescribed software, which should be installed, on the basis of the received version;
acquiring the prescribed software from the different network device when it is determined to change the prescribed software; and
installing the prescribed software, which is acquired, instead of the prescribed software which is currently installed.
